(19) United States
(12) Patent Application Publication
(10) Pub. No.: US 2010/0164685 A1
(43) Pub. Date: Jul. 1, 2010

(54) METHOD AND APPARATUS FOR ESTABLISHING DEVICE CONNECTIONS

(76) Inventors: Trevor Pering, San Francisco, CA (US); Roy Want, Lost Altos, CA (US); Kenton Lyons, San Jose, CA (US); Shivani A. Sud, Santa Clara, CA (US); Barbara Rosario, Berkeley, CA (US)

Correspondence Address: KACVINSKY LLC;C/O CPA Global, P.O. BOX 52050, MINNEAPOLIS, MN, 55402, US

(21) Appl. No.: 12/347,118

(22) Filed: Dec. 31, 2008

(51) Int. Cl. G06F 7/04; G10L 17/00

(52) U.S. Cl. 340/5.83; 704/246; 704/E17.002

(57) ABSTRACT

A system, apparatus, method and article to establish device connections are described. The apparatus may include an input device to receive identification information for a selected target device. The apparatus may also include a connection module operative to send a connection request message including the identification information to one or more target devices and receive a connection response message from the selected target device. The connection response message includes confirmation that the identification information corresponds to local identification information stored on the selected target device. The apparatus may also include a communication module operative to establish a wireless connection between the mobile computing device and the selected target device based on the corresponding identification information. Other embodiments are described and claimed.

### BACKGROUND

Mobile computing devices have become highly capable communication tools in recent years. In addition to providing voice connectivity, many mobile computing devices today support a variety of wireless data communication standards as well. Such data communication may be implemented using various technologies such as ultra-wideband (UWB), Bluetooth, wireless broadband or any of the 802.11 family of wireless local area networking (WLAN) standards, for example. Utilizing wireless connectivity as a means for communicating between mobile computing devices is becoming increasingly popular. This type of local communication connection has several advantages, including simplified networking and improved file and data sharing. Consequently, there exists a substantial need for a method and apparatus to simplify the establishment of device connections.

### BRIEF DESCRIPTION OF THE DRAWINGS

FIG. 1 illustrates one embodiment of a system.

FIG. 2 illustrates one embodiment of a message flow diagram.

FIG. 3 illustrates one embodiment of a logic diagram.

FIG. 4 illustrates a second embodiment of a system.

### DETAILED DESCRIPTION

The embodiments may generally relate to a method and apparatus for establishing wireless communication connections between mobile devices. One embodiment relates to a mobile computing device comprising an input device to receive identification information for a selected target device and a connection module operative to send a connection request message including the identification information to one or more target devices. In some embodiments, the mobile computing device receives a connection response message from the selected target device, the connection response message including confirmation that the identification information corresponds to local identification information stored on the selected target device. Based on the corresponding identification information, a communication module may establish a wireless connection between the mobile computing device and the selected target device. Other embodiments are described and claimed.

In various embodiments, users of mobile computing devices may desire to wirelessly connect two or more of mobile computing devices together to transfer data or otherwise directly communicate. For example, if two users are involved in a conversation and one would like to send a message to the other, a connection will be required between their mobile computing devices. Prior solutions to this problem are cumbersome and typically require user intervention on both sides of the transaction. For example, with a name-based network discovery process, a user may be required to select the name of a desired target device to initiate a connection. This may be problematic in areas where many wireless devices are available or the target device has a non-descriptive name that is difficult to identify. Additionally, this approach often requires authorization from the target device before a connection can be established.

Another approach to establishing a connection involves directly entering contact information for a target device into a source device and manually establishing a connection. For example, this approach may require a user to request the contact information for a target device from another user, manually enter the information, verify the information, and then send a message to the target device to establish communication. This technique requires either knowing the recipients address or contact number or acquiring this information from the user of the target device. Other techniques are also currently used, such as infrared connections to exchange data or near field communication (NFC) techniques to establish a connection, both of which require the presence and close proximity of the mobile computing devices. Each of the above described methods, however, has drawbacks that result in inefficiencies and cumbersome use. Therefore, in various embodiments, a method of establishing a communication connection is described herein that relies on audio, visual or biometric data related to a target device to initiate and establish a connection with the target device with no requirement for physical interaction with the target device. Other embodiments are described and claimed.

Numerous specific details are set forth to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

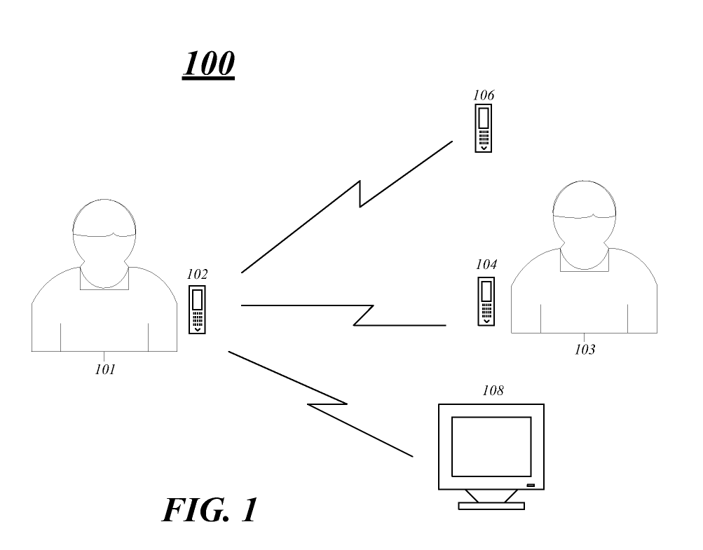

FIG. 1 illustrates one embodiment of a system. FIG. 1 illustrates a system 100. System 100 may be representative of the one or more embodiments described herein. System 100 includes users 101 and 103 and computing devices 102, 104, 106 and 108. The computing devices 102, 104, 106 and 108 may comprise any computing device capable of wireless communication. For example, computing devices 102, 104 and 106 may comprise mobile computing devices, mobile telephones or smartphones in various embodiments, or a laptop computer. Computing device 108 may comprise a monitor or display in some embodiments. Although FIG. 1 may show a limited number of devices by way of example, it can be appreciated that a greater or a fewer number of devices may be employed for a given implementation.

In various embodiments, a user such as user 101 or 103, may wish to establish a wireless connection between two or more of the mobile computing devices 102, 104, 106 or 108. For example, mobile computing device 102 may be under the control of user 101 and mobile computing device 104 may be under the control of user 103 in various embodiments. User 101 may wish to establish a connection between mobile computing device 102 (e.g. the source device) and mobile computing device 104 (e.g. the target device), for example. To begin the connection process, user 101 may utilize an input device associated with mobile computing device 102 to capture an analog input that represents the mobile computing device 104. In some embodiments, the analog input may comprise identification information for the target device 104. It should be understood that the identification information utilized by the source device (e.g. mobile computing device 102) to establish a connection with any of the target devices (e.g. mobile computing devices 104, 106, 108, etc.) should be selected to correspond to local identification stored on any of the target devices.

In various embodiments, mobile computing device 102 may include a plurality of input devices. For example, the input devices may comprise at least one of a camera, microphone, touchscreen display, biometric devices or any other suitable input device. In some embodiments, the biometric devices may include a fingerprint scanner, retinal scanner or iris scanner, for example.

The identification information captured by the input device may include one of a picture of a user of the selected target device, a picture of the selected target device, a picture representing the selected target device, or a set of computed features that represent the picture of the user, the picture of the selected target device or the picture representing the selected target device in various embodiments. The pictures representing the target device may be captured using a camera integrated within mobile computing device 102, for example.

In some embodiments, user 101 may take a picture of user 103 using a camera built into mobile computing device 102 and use the picture of user 103 as identification information to establish a connection between mobile computing devices 102 and 104, for example. User 101 may also take a picture of mobile computing device 108 or of any suitable image representing mobile computing device 108 to be used as identification information to establish a connection between mobile computing device 102 and mobile computing device 108 in various embodiments.

In some embodiments, the identification information may comprise one of a speech sample from a user of the selected target device, a sound representing the selected target device or a set of computed features that represent the speech sample or the sound. For example, the speech sample may comprise a recording of the user of the selected target device (e.g. user 103 of target device 104) speaking his or her name. The sound representing the target device 104 may be captured using any suitable input of source device 102, such as the internal microphone for example. Other embodiments are described and claimed.

For example, user 101 of mobile computing device 102 may be involved in a conversation with user 103 of mobile computing device 104. If the users 101 and 103 desire to establish a connection between their mobile computing devices 102 and 104, user 101 may simply ask user 103 to speak his name into mobile computing device 102 to be used as identification information to establish a connection between source device 102 and target device 104. It should be understood that any sound may be used as identification information as long as the sound matches locally stored identification information on the target device.

The identification may include biometric information or a set of computed features that represent biometric information about a user of the mobile computing device in some embodiments. For example, the identification information may comprise a finger print scan of user 103, a retinal scan of user 103 or an iris scan of user 103. Any suitable biometric device or parameter may be used and still fall within the described embodiments.

In some embodiments, user 101 of mobile computing device 102 may be desire to establish a connection with mobile computing device 104 controlled by user 103. To establish the connection between the mobile computing devices 102 and 104, user 101 may simply ask user 103 to input biometric information into mobile computing device 102 to be used as identification information to establish a connection between source device 102 and target device 104. For example, user 103 may touch his finger to a touchscreen display of mobile computing device 102 to have his fingerprint read by a fingerprint scanner of mobile computing device 102. In various embodiments, any suitable biometric input and any biometric input device may be used as identification information as long as the captured biometric identification information matches locally stored identification information on the target device. Other embodiments are described and claimed.

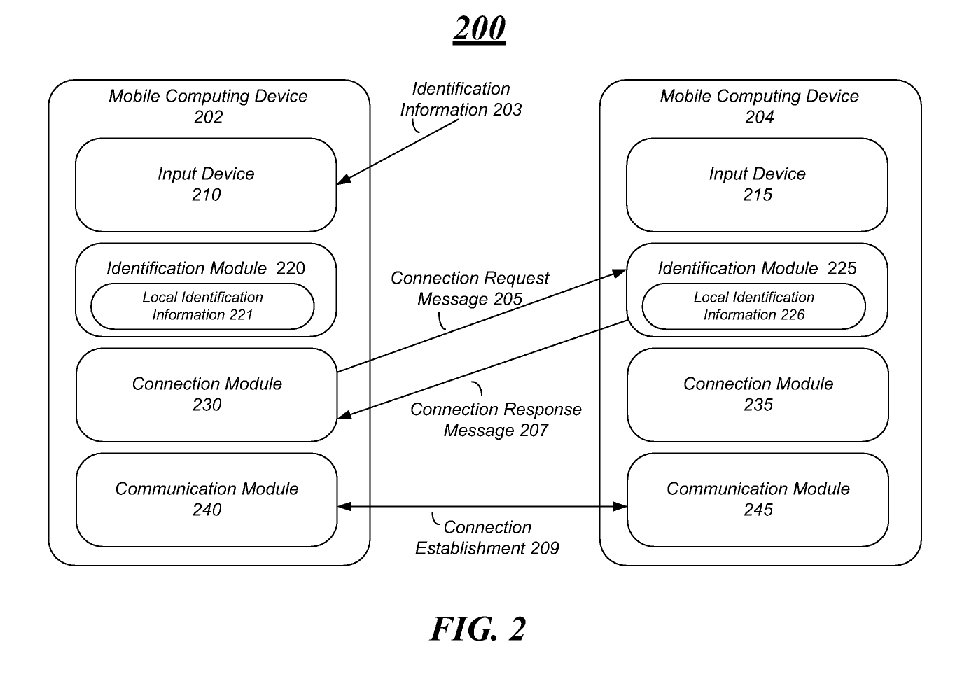

After the identification information is received at the source device 102, the connection process and exchange of information may begin. The establishment of the connection between the mobile computing devices may be better understood with reference to the message flow diagram illustrated in FIG. 2.

FIG. 2 illustrates a message flow diagram 200. As shown, FIG. 2 includes a mobile computing device 202 and a mobile computing device 204. Mobile computing devices 202 and 204 may be representative of any of the mobile computing devices 102, 104, 106 or 108 of FIG. 1, for example. In various embodiments, mobile computing device 202 may comprise a source device and mobile computing device 204 may comprise a target device. Each mobile computing device 202 and 204 includes an input device 210, 215, an identification module 220, 225, local identification information 221, 226, a connection module 230, 235 and a communication module 240, 245. Although mobile computing devices 202 and 204 may show a limited number of components or modules by way of example, it can be appreciated that a greater or a fewer number of components or modules may be employed for a given implementation.

Identification information 203 may be received at an input device 210 of mobile computing device 202 in various embodiments. Input device 210 may comprise one of a camera, microphone, touchscreen display or biometric device as described above with reference to FIG. 1. Additionally, the identification information 203 may comprise any picture, sound, biometric information or computed features representing a picture, sound or biometric information as described above with reference to FIG. 1. The identification information 203 should be selected to correspond with local identification information 226 of the target device 204.

Connection request message 205 may be sent from connection module 230 of source device 202 to identification module 225 of target device 204 in some embodiments. The connection request message 205 may include the identification information 203 in various embodiments. Additionally, the connection request message 205 may also include contact information for the source device 202 in some embodiments. The contact information may comprise an email address for a user of the source device in various embodiments. The identification information 203 sent with connection request message 205 may only be recognized by the intended target device 204. While FIG. 2 illustrates connection request message 205 being sent to only one device (e.g. target device 204), it should be understood that connection request message 205 may be broadcast to any number of devices within wireless communication range of source device 202 and still fall within the described embodiments. In some embodiments, the connection request message 205 may be sent to any number of target devices within a predefined proximity of the source device 202.

In some embodiments, connection request message 205 is sent as part of a wireless discovery protocol. For example, connection request message 205 may be part of a Bluetooth discovery protocol, a Universal Plug and Play (UPnP) discovery protocol, link layer discovery protocol, layer 2 discovery protocol, secure discovery protocol or any other suitable discovery protocol.

Connection request message 205, along with identification information 203 or computed features representing the identification information, may be received by identification module 225 of target computing device 204 and any other target devices in various embodiments. Identification module 225 may be operative to automatically compare the received identification information 203 to local identification information 226 stored on mobile computing device 204. Local identification information 226 may be any suitable identification information selected, captured and stored by a user of mobile computing device 204. For example, a user of mobile computing device 204 may take a picture of themselves, and store this image or a digital representation of the image as the local identification information 226. Other embodiments are described and claimed.

In various embodiments, the automatic comparison may comprise utilizing one of a visual, auditory or biometric algorithm to compare the received identification information 203 and the local identification information 226. In some embodiments, the identification module 225 may generate feature vectors representing the received identification information 203 and the local identification information 226 and utilize the visual, auditory or biometric algorithm to compare the feature vectors.

If the received identification information 203 corresponds to the local identification information 226, identification module 225 may automatically respond to connection request message 205 with a connection response message 207. In some embodiments, prior to or instead of automatically responding with a connection response message 207, the target device 204 may generate a connection prompt if the received identification information 203 corresponds to the local identification information 226. For example, target device 204 may generate a connection prompt to be displayed to a user of target device 204. The user of target device 204 may accept or deny the request to establish a connection with the source device 202 based on the connection prompt. A response to the connection prompt may be received at the target device and a connection with source device 202 may be established based on the response.

In various embodiments, after receiving a response to the connection prompt, the communication module 235 may be operative to generate a communication message intended for the source device 202 using the contact information received in the connection request message 205 instead of automatically establishing a connection with the source device 202. For example, if the user of target device 204 accepts the connection request prompt, target device 204 may automatically send a communication message, such as an email message for example, to the owner of source device 202. The communication message may include contact information for the target device 204 in some embodiments. Other embodiments are described and claimed.

In various embodiments, if a connection response message 207 is automatically generated by target device 204, connection response message 207 may be received by connection module 230 of source device 202 along with the confirmation that the identification information 203 corresponded to the local identification information 226. In some embodiments, target devices that receive a connection request message 205 and do not identify corresponding identification information may send no response. In other embodiments, target devices that do not contain corresponding identification information may respond with a no match response indicating that they are not the intended target device.

Based on a positive connection response message 207 indicating that corresponding identification information was found, communication module 240 may send and communication module 245 may accept connection establishment 209, therein establishing a connection between source device 202 and target device 204. The established communication connection may comprise any suitable wireless connection, such as one of a ultra-wideband (UWB) connection, a Bluetooth connection, a wireless local area network (WLAN) connection, a cellular connection, a wireless broadband connection, an email connection or a short message service (SMS) connection, for example.

In various embodiments, each mobile computing device may include various physical and/or logical components for communicating information which may be implemented as hardware components (e.g., computing devices, processors, logic devices), executable computer program instructions (e.g., firmware, software) to be executed by various hardware components, or any combination thereof, as desired for a given set of design parameters or performance constraints. Exemplary mobile computing devices with which connections may be established include a personal computer (PC), desktop PC, notebook PC, laptop computer, mobile computing device, smart phone, personal digital assistant (PDA), mobile telephone, combination mobile telephone/PDA, video device, television (TV) device, digital TV (DTV) device, high-definition TV (HDTV) device, media player device, gaming device, messaging device, or any other suitable communications device in accordance with the described embodiments.

The mobile computing devices may form part of a wired communications system, a wireless communications system, or a combination of both. For example, the mobile computing devices may be arranged to communicate information over one or more types of wired communication links such as a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The mobile computing devices may be arranged to communicate information over one or more types of wireless communication links such as a radio channel, satellite channel, television channel, broadcast channel infrared channel, radio-frequency (RF) channel, Wireless Fidelity (WiFi) channel, a portion of the RF spectrum, and/or one or more licensed or license-free frequency bands. In wireless implementations, the mobile computing devices may comprise one more interfaces and/or components for wireless communication such as one or more transmitters, receivers, transceivers, amplifiers, filters, control logic, wireless network interface cards (WNICs), antennas, and so forth. Although certain embodiments may be illustrated using a particular communications media by way of example, it may be appreciated that the described embodiments may be implemented using various communication media and accompanying technology.

Examples of systems and devices in which embodiments described herein can be incorporated comprise wireless local area network (WLAN) systems, wireless metropolitan area network (WMAN) systems, wireless personal area networks (WPAN), wide area networks (WAN), cellular telephone systems, radio networks, computers, and wireless communication devices, among others. Those skilled in the art will appreciate, based on the description provided herein, that the embodiments may be used in other systems and/or devices.

Embodiments of systems and devices described herein may comply or operate in accordance with a multitude of wireless standards. For example, a system and associated nodes may comply or communicate in accordance with one or more wireless protocols, which may be defined by one or more protocol standards as promulgated by a standards organization, such as the Internet Engineering Task Force (IETF), International Telecommunications Union (ITU), the Institute of Electrical and Electronics Engineers (IEEE), and so forth. In the context of a WLAN system, the nodes may comply or communicate in accordance with various protocols, such as the IEEE 802.11 series of protocols (e.g., wireless fidelity or WiFi). In the context of a WMAN system, the nodes may comply or communicate in accordance with the IEEE 802.16 series of protocols such as the Worldwide Interoperability for Microwave Access (WiMAX), for example. Those skilled in the art will appreciate that WiMAX is a standards-based wireless technology to provide high-throughput broadband connections over long distances (long range). WiMAX can be used for a number of applications, including “last mile” wireless broadband connections, hotspots, cellular backhaul, and high-speed enterprise connectivity for business. In the context of a personal area network (PAN), the nodes may comply or communicate in accordance with the IEEE 802.15 series of protocols otherwise known as Bluetooth, for example. In the context of a MAN, the nodes may comply or communicate in accordance with the IEEE 802.20 series of protocols, for example. For mobility across multiple networks, the nodes may comply or communicate in accordance with the IEEE 802.21 series of protocols, for example. In other embodiments, the system and nodes may comply with or operate in accordance with various WMAN mobile broadband wireless access (MBWA) systems, protocols, and standards, for example. The embodiments, however, are not limited in this context.

Embodiments of systems and devices described herein may comply or operate in accordance with a multitude of wireless technologies and access standards. Examples of wireless technologies and standards may comprise cellular networks (e.g., Global System for Mobile communications or GSM), Universal Mobile Telecommunications System (UTS), High-Speed Downlink Packet Access (HSDPA), Broadband Radio Access Networks (BRAN), General Packet Radio Service (GPRS), 3.sup.rd Generation Partnership Project (3GPP), and Global Positioning System (GPS); and Ultra Wide Band (UWB), Code Division Multiple Access (CDMA), CDMA 2000, Wideband Code-Division Multiple Access (W-CDMA), Enhanced General Packet Radio Service (EGPRS), among others. Systems and devices in accordance with various embodiments may be arranged to support multiple heterogeneous wireless devices to communicate over these wireless communication networks. The embodiments, however, are not limited in this context.

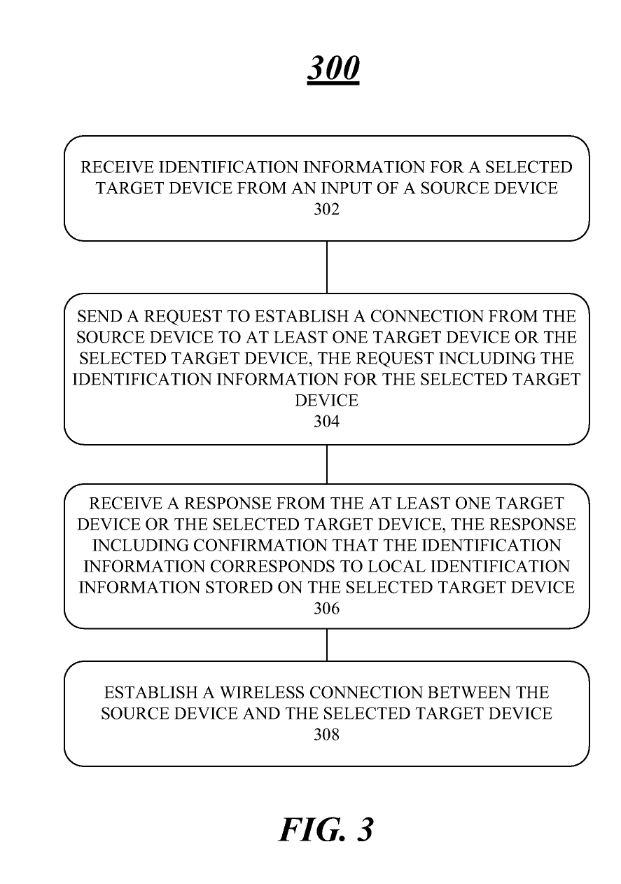

FIG. 3 illustrates one embodiment of a logic flow. FIG. 3 illustrates a logic flow 300. Logic flow 300 may be representative of the operations executed by one or more embodiments described herein. As shown in logic flow 300, identification information for a selected target device may be received from an input of a source device at 302. For example, input device 210 of source device 202 may receive identification information 203 for a selected target device, such as target device 204. At 304, a request to establish a connection may be sent from the source device to at least one target device or the selected target device, the request including the identification information for the selected target device. In some embodiments, for example, connection module 230 of source device 202 may send a connection request message 205 to an identification module 225 of a target device 204. The connection request message 205 may include the identification information 203 in various embodiments.

At 306, a response may be received from the at least one target device or the selected target device, the response including confirmation that the identification information corresponds to local identification information stored on the selected target device. For example, identification module 225 of target device 204 may respond to the connection request message 205 with a connection response message 207 indicating that identification information 203 corresponds to local identification information 226 stored on target device 204. At 308, a wireless connection may be established between the source device and the selected target device. For example, source device 202 and target device 204 may establish a wireless connection. Other embodiments are described and claimed.

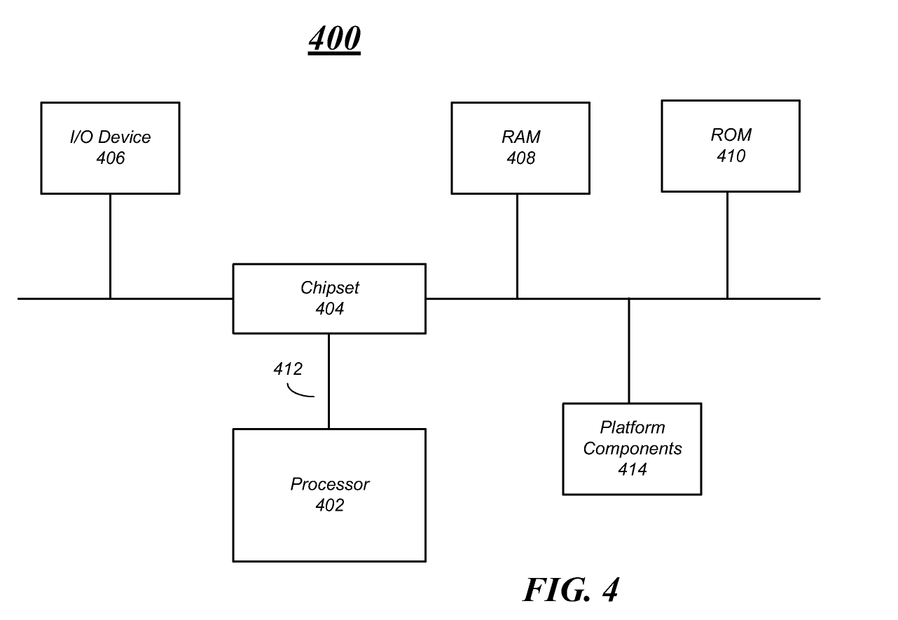

FIG. 4 is a diagram of an exemplary system embodiment. In particular, FIG. 4 is a diagram showing a system 400, which may include various elements and may represent any of the above described mobile computing devices, for example. For instance, FIG. 4 shows that system 400 may include a processor 402, a chipset 404, an input/output (I/O) device 406, a random access memory (RAM) (such as dynamic RAM (DRAM)) 408, and a read only memory (ROM) 410, and various platform components 414 (e.g., a heat sink, DTM system, cooling system, housing, vents, and so forth). These elements may be implemented in hardware, software, firmware, or any combination thereof. The embodiments, however, are not limited to these elements.

In particular, the platform components 414 may include a cooling system implementing various DTM techniques. The cooling system may be sized for the system 400, and may include any cooling elements designed to perform heat dissipation, such as heat pipes, heat links, heat transfers, heat spreaders, vents, fans, blowers, and liquid-based coolants.

As shown in FIG. 4, I/O device 406, RAM 408, and ROM 410 are coupled to processor 402 by way of chipset 404. Chipset 404 may be coupled to processor 402 by a bus 412. Accordingly, bus 412 may include multiple lines.

Processor 402 may be a central processing unit comprising one or more processor cores (102-1-m). The processor 402 may include any type of processing unit, such as, for example, CPU, multi-processing unit, a reduced instruction set computer (RISC), a processor that have a pipeline, a complex instruction set computer (CISC), digital signal processor (DSP), and so forth.

Processor 402 may operate at different performance levels. Accordingly, processor 402 may enter into various operational states, such as one or more active mode P-states. Thus, processor 402 may include features described above with reference to FIGS. 1-3. For instance, processor 402 may include the elements of any of the above described mobile computing devices, among others.

Although not shown, the system 400 may include various interface circuits, such as an Ethernet interface and/or a Universal Serial Bus (USB) interface, and/or the like. In some exemplary embodiments, the I/O device 406 may comprise one or more input devices connected to interface circuits for entering data and commands into the system 400. For example, the input devices may include a keyboard, mouse, touch screen, track pad, track ball, isopoint, a voice recognition system, camera, microphone, touchscreen display, biometric device and/or the like. Similarly, the I/O device 406 may comprise one or more output devices connected to the interface circuits for outputting information to an operator. For example, the output devices may include one or more displays, printers, speakers, and/or other output devices, if desired. For example, one of the output devices may be a display. The display may be a cathode ray tube (CRTs), liquid crystal displays (LCDs), or any other type of display.

The system 400 may also have a wired or wireless network interface to exchange data with other devices via a connection to a network. The network connection may be any type of network connection, such as an Ethernet connection, digital subscriber line (DSL), telephone line, coaxial cable, etc. The network may be any type of network, such as the Internet, a telephone network, a cable network, a wireless network, a packet-switched network, a circuit-switched network, and/or the like.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a storage medium, a computer-readable medium or an article of manufacture which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It should be understood that embodiments may be used in a variety of applications. Although the embodiments are not limited in this respect, certain embodiments may be used in conjunction with many electronic devices, such as a personal computer, a desktop computer, a mobile computer, a laptop computer, a notebook computer, a tablet computer, a server computer, a network, a Personal Digital Assistant (PDA) device, a wireless communication station, a wireless communication device, a cellular telephone, a mobile telephone, a wireless telephone, a PDA device or the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A mobile computing device, comprising:
an input device to receive identification information for a selected target device;
a connection module operative to send a connection request message including the identification information or computed features representing the identification information to one or more target devices and receive a connection response message from the selected target device, the connection response message including confirmation that the identification information corresponds to local identification information stored on the selected target device; and
a communication module operative to establish a wireless connection between the mobile computing device and the selected target device based on the corresponding identification information.

2. The mobile computing device of claim 1, wherein the input device comprises at least one of a camera, microphone, touchscreen display or biometric device.

3. The mobile computing device of claim 1, wherein the identification information comprises one of a picture of a user of the selected target device, a picture of the selected target device, a picture representing the selected target device, or a set of computed features that represent the picture of the user, the picture of the selected target device or the picture representing the selected target device.

4. The mobile computing device of claim 1, wherein the identification information comprises one of a speech sample from a user of the selected target device, a sound representing the selected target device or a set of computed features that represent the speech sample or the sound.

5. The mobile computing device of claim 4, wherein the speech sample comprises a recording of the user of the selected target device speaking his or her name.

6. The mobile computing device of claim 1, wherein the connection request message includes contact information for the mobile computing device or a user of the mobile computing device, the communication module is operative to receive a communication message from the target device, the communication message including contact information for the target device or a user of the target device, and no connection response message is received by the mobile computing device.

7. An apparatus, comprising:
an identification module operative to receive a connection request message including identification information or computed features representing the identification information from a source device, automatically compare the received identification information to local identification stored on a target device, generate a connection prompt if the received identification information corresponds to the local identification information; and
a communication module operative to establish a wireless connection between the target device and the source device based on a received response to the connection prompt.

8. The apparatus of claim 7, wherein the local identification information comprises one of a picture of a user of the mobile computing device, a picture of the target device, a picture representing the target device, or a set of computed features that represent the picture of the user, the picture of the target device or the picture representing the target device.

9. The apparatus of claim 7, wherein the local identification information comprises one of a speech sample from a user of the target device, a sound representing the target device or a set of computed features that represent the speech sample or the sound.

10. The apparatus of claim 9, wherein the speech sample comprises a recording of the user of the target device speaking his or her name.

11. The apparatus of claim 7, wherein the local identification information comprises biometric information or a set of computed features that represent biometric information about a user of the target device, the biometric information including one of a fingerprint, retinal scan or iris scan.

12. The apparatus of claim 7, wherein the automatic comparison comprises using one of a visual, auditory or biometric algorithm to compare the received identification information and the local identification information.

13. The apparatus of claim 12, wherein the identification module generates feature vectors representing the received identification information and the local identification information and the visual, auditory or biometric algorithm compares the feature vectors.

14. The apparatus of claim 7, wherein the connection request message includes contact information for the source device or a user of the source device and the communication module is operative to generate a communication message intended for the source device using the contact information received in the connection request message, the communication message including contact information for the target device or a user of the target device.

15. A method, comprising:
receiving identification information for a selected target device from an input of a source device;
sending a request to establish a connection from the source device to at least one target device or the selected target device, the request including the identification information or computed features representing the identification information for the selected target device;
receiving a response from the at least one target device or the selected target device, the response including confirmation that the identification information corresponds to local identification information stored on the selected target device; and
establishing a wireless connection between the source device and the selected target device.

16. The method of claim 15, wherein the request is sent to a plurality of target devices within a predetermined proximity of the source device.

17. The method of claim 15, wherein the identification information comprises one of a picture of a user of the selected target device, a picture of the selected target device, a picture representing the selected target device, or a set of computed features that represent the picture of the user, the picture of the selected device or the picture representing the selected target device.

18. The method of claim 15, wherein the identification information comprises one of a speech sample from a user of the selected target device, a sound representing the selected target device or a set of computed features that represent the speech sample or the sound.

19. The method of claim 18, wherein the speech sample comprises a recording of the user of the selected target device speaking his or her name.

20. The method of claim 15, wherein the request includes contact information for the source device or a user of the source device, the response comprises a communication message from the target device, the communication message including contact information for the target device or a user of the target device, and no wireless connection is established between the source device and the selected target device.
